(19) United States
(12) Patent Application Publication
(10) Pub. No.: US 2026/0211745 A1
(43) Pub. Date: Jul. 23, 2026

(54) METHODS FOR DISTRIBUTING SERVER SIDE APPLICATION COMPUTING RESOURCES AND ASSOCIATED SYSTEMS AND DEVICES

(71) Applicant: Panasonic Avionics Corporation, Irvine, CA (US)

(72) Inventors: Andrew BARNES, Mission Viejo, CA (US); Yichao JIANG, Irvine, CA (US); Vrajesh MEHTA, La Palma, CA (US); Attila SZILAGYI, Santa Ana, CA (US)

(21) Appl. No.: 19/035,410

(22) Filed: Jan. 23, 2025

(51) Int. Cl. G06F 9/50; H04N 21/214

(52) U.S. Cl. CPC G06F 9/5083; G06F 9/505; G06F 9/5072; G06F 9/5077; H04N 21/2146; G06F 2209/505; G06F 2209/508

(57) ABSTRACT

Methods for distributing server side application computing resources and associated systems and devices are disclosed herein. In some embodiments, a method for distributing workload across an in-flight entertainment (IFE) system includes (i) determining real-time and anticipated excess compute capacities of a plurality of compute resources, (ii) identifying one or more compute resources among the plurality of compute resources based on the one or more compute resources having real-time and/or anticipated excess compute capacities above a threshold, (iii) forming one or more compute clusters, (ii) obtaining an allocation scheme, and (iii) assigning computational tasks to the one or more compute clusters based on the obtained allocation scheme. Determining can comprise accessing a manifest file configured to monitor the plurality of compute resources. Determining the anticipated excess compute capacities of the plurality of compute resources can comprise analyzing historical compute resource usage data associated with a current flight route.

### TECHNICAL FIELD

The present technology generally relates to methods for distributing server side application computing resources across an in-flight entertainment system, and associated systems and devices.

### BACKGROUND

Commercial aircraft today often include in-flight entertainment (IFE) devices that can interact with passengers to provide various forms of entertainment (e.g., movies, music, TV shows, etc.), flight-tracking programs, and other services. The IFE devices are often managed by an IFE headend server in the aircraft. As new features for IFE devices are developed, the IFE system may need to be updated to accommodate the increased computational demands of such features. However, it can be cost prohibitive to frequently update the IFE headend server, and the overall IFE system can be limited by the outdated hardware and software associated with the IFE headend server. For example, in addition to having insufficient computing resources for supporting modern applications, outdated IFE headend servers can force developers wanting to maintain a common set of products to ensure compatibility of new applications across multiple generations, potentially sacrificing the quality of such new applications. Therefore, there is a need for an IFE system that can scale and adapt to new applications and other technological developments without requiring the headend server to be replaced frequently.

### BRIEF DESCRIPTION OF THE DRAWINGS

Features, aspects, and advantages of the presently disclosed technology may be better understood with regard to the following drawings.

FIG. 1 shows an example of an in-flight entertainment (IFE) system installed in an airplane based on some implementations of the disclosed technology.

FIG. 2 shows an example block diagram of a computing device based on some implementations of the disclosed technology.

FIG. 3 is a schematic block diagram of an IFE system based on some implementations of the disclosed technology.

FIG. 4 is a flowchart illustrating a method for distributing workload across an IFE system based on some implementations of the disclosed technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present technology are directed to methods for distributing server side application computing resources and associated systems and devices. In many in-flight entertainment (IFE) systems, one or more headend servers manage the distribution of multimedia content to IFE devices, such as seatback screens each associated with a passenger seat. As new features, new use cases, and other technological improvements for IFE systems are developed, existing headend servers may lack the computational resources required to properly support such improvements, which are ever increasing in computational demand. However, frequently updating or replacing (and thus certifying) headend servers can be cost prohibitive and/or otherwise difficult due to significant variations in physical interfaces among different aircraft. Thus, challenges associated with keeping outdated headend servers continue to exacerbate over time. For example, developers wanting to maintain a common set of products may be required to ensure compatibility of new features across multiple generations (e.g., ensure compatibility with both the outdated headend servers and newer models of IFE devices). Some have proposed developing a single, universal headend line replaceable unit (LRU). However, due to significant variations in aircraft design and wiring, developing such a universal headend LRU can be difficult and offer minimal cost saving benefits.

Embodiments of the present technology address at least some of the above described issues for scaling IFE systems to accommodate future technological developments with, e.g., increased computational demands. For example, embodiments of the present technology include a method for distributing workload across an IFE system. The method can include (i) forming one or more compute clusters, (ii) obtaining an allocation scheme, and (iii) assigning computational tasks to the one or more clusters based on the obtained allocation scheme. Forming the one or more compute clusters can include identifying one or more compute resources in the IFE system having real-time and/or anticipated excess compute capacity. The identified one or more compute resources and a headend server of the IFE system can form one or more cluster nodes of the one or more compute clusters. The allocation scheme can define a distribution of the computational tasks among the one or more cluster nodes of the one or more compute clusters. The computational tasks can be assigned to the one or more cluster nodes.

In some embodiments of the present technology, an IFE system can include an IFE headend server and a plurality of seat-based compute resources, each operably coupled to the IFE headend server. The IFE headend server and/or the plurality of seat-based compute resources can include one or more processors configured to (i) form one or more compute clusters, (ii) obtain an allocation scheme, and (iii) assign computational tasks to the one or more clusters based on the obtained allocation scheme. The one or more compute clusters can be formed based on identifying one or more of the plurality of seat-based compute resources having real-time and/or anticipated excess compute capacity. The identified one or more of the plurality of seat-based compute resources and the IFE headend server can form one or more cluster nodes of the one or more compute clusters. The allocation scheme can define a distribution of computational tasks among the one or more cluster nodes of the one or more compute clusters. The computational tasks can be assigned to the one or more cluster nodes.

By making use of excess, spare, or otherwise available compute capacity on hardware installed on or around passenger seats, embodiments of the present technology not only reduce the workload on headend servers, but also leverage processors on IFE devices, which may include more advanced features and capabilities compared to the processors included in headend servers. Compared to headend servers, individual IFE devices are often easier and cheaper to update and/or replace. Therefore, the overall IFE system can scale and adapt to new technologies more efficiently and in a more cost-effective manner, and without the need to upgrade or replace the headend servers and/or rewire the aircraft.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Select Embodiments of an IFE System

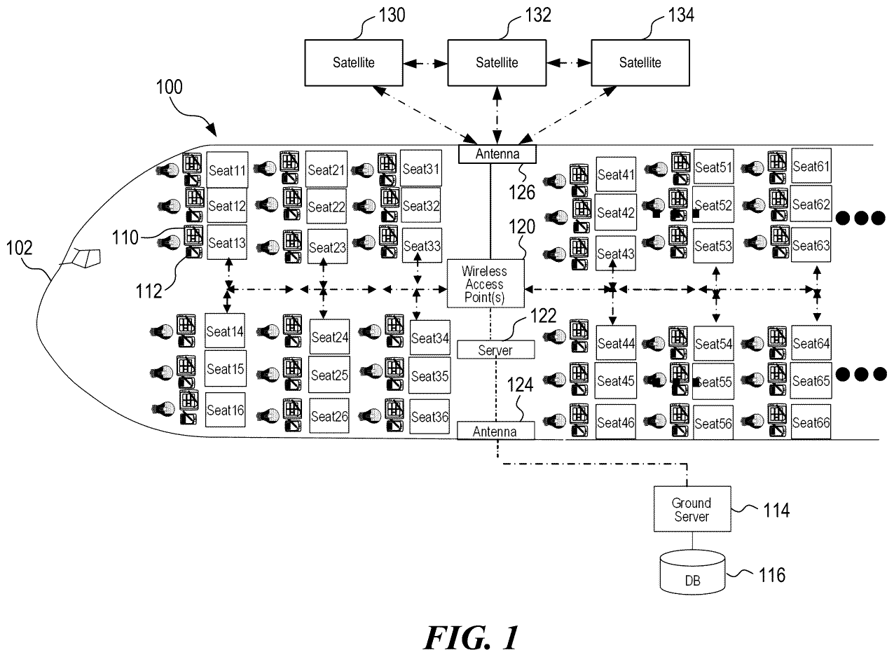

FIG. 1 shows an example of an IFE system 100 installed in an airplane 102 based on some implementations of the disclosed technology. The IFE system 100 provides various entertainment and connectivity services to passengers on board via one or more IFE devices 110 dedicated to each seat. In the illustrated implementation, the IFE system 100 includes a wireless access point 120, a server 122, antenna 124, and antenna 126. The components shown as a single element in FIG. 1 (e.g., the server 122, the wireless access point 120, etc.) can be configured in multiple elements. For example, the IFE system 100 can include multiple wireless access points 120 to facilitate or support providing wireless coverages for the passengers. The passengers can carry their own personal electronic devices (PEDs) 112 and/or other devices. The PEDs 112 may refer to any electronic computing device that includes one or more processors or circuitries for implementing the functions related to data storage, video and audio streaming, wired communications, wireless communications, etc. Examples of the PEDs 112 include cellular phones, smart phones, tablet computers, laptop computers, and other portable computing devices. In some implementations, the PEDs 112 may have the capability to execute application software programs (“apps”) to perform various functions. In some implementations, the PEDs 112 can be connected to the IFE devices 110 to transfer data and/or power therebetween.

In FIG. 1, the airplane 102 is depicted to include multiple passenger seats, individually labeled Seat 11 to Seat 66. The IFE devices 110 are configured with capabilities for video and audio streaming, Internet communications, and other capabilities. In some implementations, the IFE devices 110 are provided at each passenger seat, such as at each of the seatbacks of the passenger seats, on cabin walls, and/or deployable from an armrest for seats located at a bulkhead (i.e., in the first row of a section). The IFE devices 110 can include displays providing interfaces to each passenger through which each passenger enters his or her selections on the entertainment option, e.g., the particular selections, emergency requests, etc. Upon receiving the selection from the passengers, based on the selections from the passengers, the IFE devices 110 can display entertainment content and travel information.

Each of the server 122, the IFE devices 110, and the PEDs 112 can include one or more processors and/or other computing units. The server 122 can be communicably coupled with the IFE devices 110 and/or the PEDs 112 and perform various operations including processing requests/inputs from passengers and providing data to passengers. The communications between the server 122, the IFE devices 110, and/or the PEDs 112 can be realized by wired and/or wireless connections. In some implementations, the communication between the server 122, the IFE devices 110, and/or the PEDs 112 is achieved through the antenna 124 to and from a ground server 114 by, for example, a provision of network plugs at the seat for plugging the PEDs 112 to a wired onboard local area network. In some implementations, the communications between the server 122, the IFE devices 110, and/or the PEDs 112 are achieved through the antenna 126 to and from satellites 130, 132, 134 in an orbit (e.g., via a cellular network utilizing one or more onboard base station(s), Wi-Fi utilizing the wireless access point 120, and/or Bluetooth).

The server 122, the IFE devices 110, and the PEDs 112 can form a local network onboard the airplane 102 through an onboard router (not shown). The local network can communicate, via the antenna 124, with the ground server 114, which can be located at various locations, including a gate where passengers check-in the boarding pass right before passengers are on board, a computer center at an arbitrary location on the ground, etc. The ground server 114 may be in communication with a ground-based database 116 and provide information from the database 116 to the server 122 and store information received from the server 122 in the database 116. Although FIG. 1 shows that the database 116 is provided separately from the ground server 114, the database 116 can be provided as a part of the ground server 114.

As discussed further herein, the IFE system 100 can utilize excess, spare, or otherwise available compute resources (e.g., processing power) of the IFE devices 110 to form one or more compute clusters. For example, a seatbox dedicated to a first or business class seat may include more compute resources (e.g., an extra central processing unit (CPU)) than needed to support the display monitor and other processing demands of the first or business class seat. The IFE system 100 can delegate computational tasks that otherwise would have been handled by the server 122 to such additional compute resources. Thus, embodiments of the present technology can not only reduce the workload of the server 122, but also take advantage of the compute resources of the IFE devices 110, which may include more advanced features and capabilities compared to the server 122.

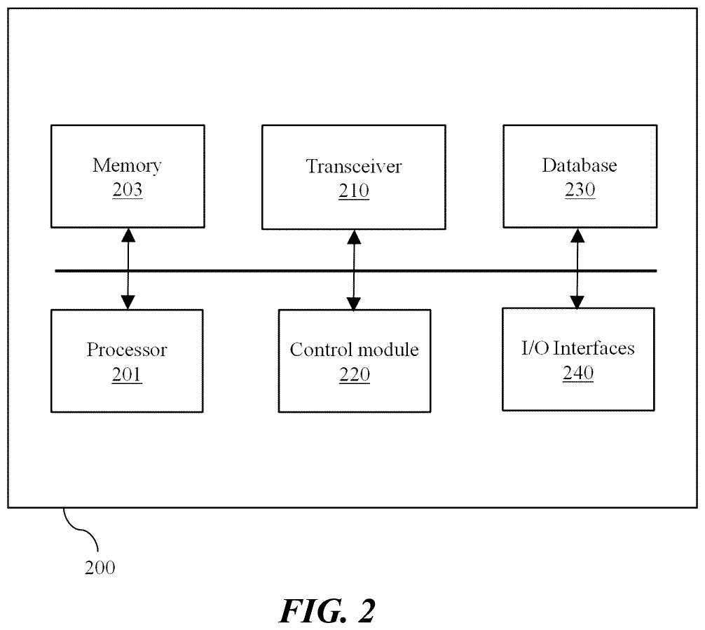

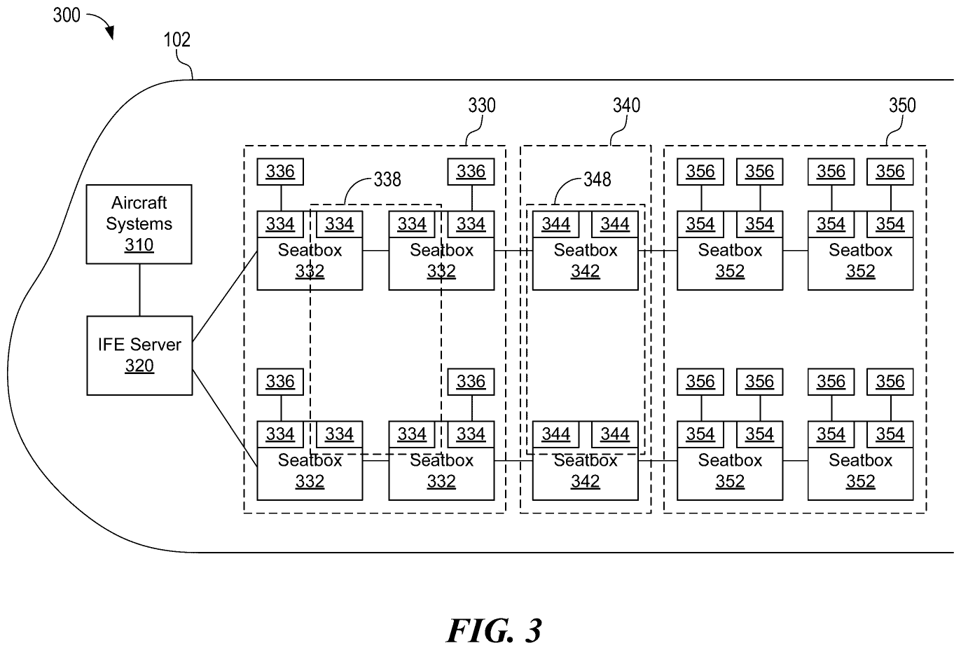

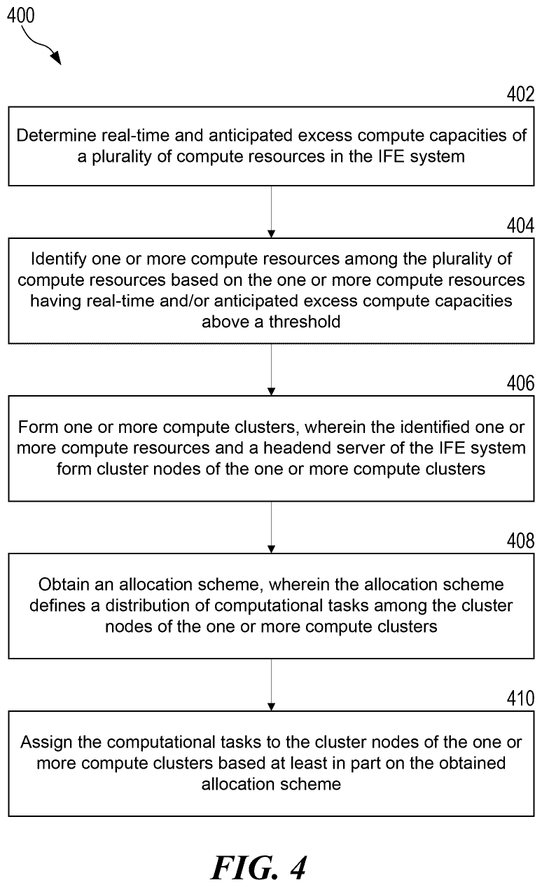

FIG. 2 is a schematic block diagram of a computing device 200 (e.g., an onboard server, a ground server, a portable server, or an IFE device) configured in accordance with embodiments of the present technology. The computing device 200 includes at least one processor 201, a memory 203, a transceiver 210, a control module 220, a database 230, and an input/output (I/O) interface 240. In other embodiments, additional, fewer, and/or different elements may be used to configure the computing device 200. The memory 203 may store instructions and applications to be executed by the processor 201. The memory 203 is an electronic holding place or storage for information or instructions so that the information or instructions can be accessed by the processor 201. The memory 203 can include, but is not limited to, any type of random access memory (RAM), any type of read-only memory (ROM), any type of flash memory, such as magnetic storage devices (e.g., hard disk, floppy disk, magnetic strips, etc.), optical disks (e.g., compact disc (CD), digital versatile discs (DVD), etc.), smart cards, flash memory devices, etc. The instructions upon execution by the processor 201 configure the computing device 200 to perform the operations (e.g., the operations as shown in and described with reference to FIGS. 3 and 4), which will be described in this patent document. The instructions executed by the processor 201 may be carried out by a special purpose computer, logic circuits, or hardware circuits. The processor 201 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 201 can perform the operations called for by that instruction.

The processor 201 (e.g., CPU(s), GPU(s), HPU(s), etc.) can be a single processing unit or multiple processing units in a device or distributed across multiple devices. The processor 201 can be operably coupled to the memory 203, the transceiver 210, the control module 220, the database 230, and the I/O interface 240 with the use of, for example, a bus, such as a PCI bus or SCSI bus to receive, send, and/or process information and to control the operations of the computing device 200. The processor 201 may retrieve a set of instructions from a permanent memory device, such as a ROM device, and copy the instructions in an executable form to a temporary memory device that is generally some form of RAM. In some implementations, the computing device 200 can include a plurality of processors that use the same or a different processing technology. The transceiver 210 may include a transmitter and a receiver. In some embodiments, the device 200 comprises a transmitter and a receiver that are separate from one another but functionally form a transceiver. The transceiver 210 can transmit or send information or data to another device (e.g., the IFE devices 110, the server 122, a reader device, etc.) and receive information or data transmitted or sent by another device (e.g., another server, another IFE device, a PED, etc.).

The control module 220 of the computing device 200 can be configured to perform operations to assist the computing device 200. In some implementations, the control module 220 can be configured as a part of the processor 201. When the computing device 200 communicates with the IFE devices 110, the server 122, and/or other components shown in FIG. 1, the control module 220 can be included in the airplane 102. In some implementations, the control module 220 can operate machine learning/artificial intelligence (AI) applications that perform various types of data analysis to automate analytical model building. Using algorithms that iteratively learn from data, machine learning applications can enable computers to learn without being explicitly programmed. The machine learning/AI module may be configured to use data learning algorithms to build models to interpret various data received from the various devices or components to detect, classify, and/or predict future outcomes. Such data learning algorithms may be associated with rule learning, artificial neural networks, inductive logic programming, and/or clustering. In some implementations, the control module 220 may assist the computing device 200 to perceive their environment and take actions that maximize the effectiveness of the operations performed by the computing device 200.

The database 230 can be configured to store various data accessible by the processor 201. In some implementations, the database 230 can be configured as part of the memory 203. In some implementations, a set of data stored on the database 230 can be swapped for a different set of data between flights depending on, e.g., the particular flight route, the departure time, the passengers onboard the airplane 102, and/or the like.

The I/O interfaces 240 can enable data to be provided to the computing device 200 as input and enable the computing device 200 to provide data as output. In some embodiments, the I/O interfaces 240 can receive computational tasks and associated instructions, and send the results of the computational tasks to other devices. In some embodiments, the I/O interfaces 240 can receive flight data from another component of the airplane 102, such as an avionics system of the airplane 102. Flight data can include GPS data, altitude data, velocity data, weather data, flight route data, and/or the like. In some embodiments, the I/O interfaces 240 may enable user input to be obtained and received by the computing device 200 (e.g., via a touch-screen display, buttons, or switches) and may enable the computing device 200 to display information. In some embodiments, the IFE devices 110, the PEDs 112, and/or other devices, including touch screen displays, buttons, controllers, audio speakers, or others, are connected to the computing device 200 via the I/O interfaces 240.

In some implementations, the computing device 200 comprises a non-transitory computer-readable medium (e.g., the memory 203) including processor instructions that, when executed by one or more processors (e.g., the processor 201), cause the one or more processors to perform a method for distributing workload across an IFE system as described in further detail below with reference to FIGS. 3 and 4.

FIG. 3 is a schematic block diagram of an IFE system 300 on the aircraft 102 based on some implementations of the disclosed technology. The IFE system 300 can be an example of the IFE system 100 of FIG. 1. The IFE system 300 can include aircraft systems 310, an IFE headend server 320 (“the server 320”), one or more IFE devices 330 associated with first class or business class seats, one or more IFE devices 340 not associated with any passenger seats, and one or more IFE devices 350 associated with economy class seats. As discussed above with reference to FIGS. 1 and 2, each of the server 320 and the IFE devices 330, 340, 350 can include one or more processors and/or other computing units, and thus can be collectively referred to as compute resources. The IFE devices 330 and the IFE devices 350 can be collectively referred to as seat-based compute resources.

The aircraft systems 310 can collect, store, and/or output data. The data can include multimedia content (e.g., movies, TV shows, music, e-books, games), flight data (e.g., GPS data, altitude information, flight route data), travel data (e.g., airport maps, example itineraries), and/or the like. The server 320 (e.g., the server 122 of FIG. 1) can be operably coupled to the aircraft systems 310 and can receive the data therefrom. The server 320 can also be operably coupled to each of the IFE devices 330, 340, 350 via wired or wireless connections. In the illustrated embodiment, the IFE devices 330, 340, 350 are connected together in one or more chains such that, e.g., the server 320 is operably coupled to the devices 350 via the IFE devices 330 and the IFE devices 340. In other embodiments, however, the server 320 can be directly coupled to individual ones of the IFE devices 330, 340, 350.

The IFE devices 330 (associated with first class or business class seats) can include one or more seatboxes 332, one or more processors 334, and one or more displays 336. In the illustrated embodiment, each seatbox 332 includes two processors 334. Also, in some embodiments, the physical distances between adjacent first class or business class seats are such that each seatbox 332 may only be coupled to one or more displays 336 corresponding to a single first class or business class seat. Moreover, a single one of the processors 334 may have a compute capacity sufficient to meet the computational demands of the one or more displays 336, among other IFE devices, corresponding to a single passenger seat. Therefore, as shown, a first one of the processors 334 in each seatbox 332 can be operably coupled to the corresponding display 336, and a second one of the processors 334 in each seatbox 332 may remain as an excess, spare, or otherwise available compute resource.

The IFE devices 350 (associated with economy class seats) can include one or more seatboxes 352, one or more processors 354, and one or more displays 356. In the illustrated embodiment, each seatbox 352 includes two processors 354. Also, in some embodiments, the physical distances between adjacent economy class seats are such that each seatbox 352 can be coupled to one or more displays 356 corresponding to multiple economy class seats. Moreover, a single one of the processors 354 may have a compute capacity sufficient to meet the computational demands of the one or more displays 356, among other IFE devices, corresponding to a single passenger seat. Therefore, as shown, a first one of the processors 354 in each seatbox 352 can be operably coupled to a first display 356 corresponding to a first economy class seat, and a second one of the processors 354 in each seatbox 352 can be operably coupled to a second display 356 corresponding to a second economy class seat adjacent to the first economy class seat.

Unlike the IFE devices 330 associated with first class or business class seats, the IFE devices 350 associated with economy class seats may lack processors that can remain as excess, spare, or otherwise available compute resources. Therefore, in some embodiments, the IFE system 300 can additionally include the devices 340, which can include one or more seatboxes 342 and one or more processors 344. As shown, each seatbox 342 can include two processors 344, neither of which is connected to any display or other IFE device. Because the processors 344 are not coupled to other IFE devices and can remain as excess, spare, or otherwise available compute resources, the inclusion of the IFE devices 340 can provide additional compute resources in cases where, e.g., there are insufficient excess seat-based compute resources. The seatboxes 342 can be installed within one or more dedicated columns along the airplane 102, or in other suitable locations.

In some embodiments, the processors 354 associated with economy class seats can each have a compute capacity more than (e.g., at least twice) the compute capacity necessary to meet the computational demands of the corresponding economy class seat. In such embodiments, the processors 354 (or portions thereof) can remain as excess, spare, or otherwise available compute resources.

In operation, the IFE system 300 can distribute workload (e.g., computational tasks) across the server 320 and the IFE devices 330, 340, 350. More specifically, the IFE system 300 can form one or more compute clusters using excess compute resources. For example, the processors 334 associated with first class or business class seats but not used for supporting the displays 336 or other IFE devices can form a first compute cluster 338, and the processors 344, none of which are used for supporting displays or other IFE devices, can form a second compute cluster 348. The IFE system 300 can then delegate computational tasks to the server 320, the first compute cluster 338, and/or the second compute cluster 348. The specific manner of delegation can depend on various factors, such as (i) the type of the computational task to be delegated, (ii) the amount of available computational power on each of the server 320, the first compute cluster 338, and the second compute cluster 348, (iii) whether an associated seat is currently occupied by a passenger, and/or the like. Further operational details of the IFE system 300 are discussed further below with reference to FIG. 4.

### III. Select Embodiments of a Method for Distributing Workload Across an IFE System

FIG. 4 is a flowchart illustrating a method for distributing workload across an IFE system based on some implementations of the disclosed technology. The method 400 can be performed by one or more processors included in the IFE system itself, such as the processors of the server 320 and/or the processors 334, 344, 354 of FIG. 3. While the steps of the method 400 are described below in a particular order, one or more of the steps can be performed in a different order or omitted, and the method 400 can include additional and/or alternative steps. Additionally, although the method 400 may be described below with reference to the embodiments of the present technology described herein, the method 400 can be performed with other embodiments of the present technology.

The method 400 begins at block 402 by determining real-time and anticipated excess compute capacities of a plurality of compute resources in the IFE system. The plurality of compute resources can include processors, servers, and/or other computational units on the aircraft, such as one or more seatboxes, seatback monitors, area distribution boxes, and/or other IFE devices of the IFE system. In some embodiments, determining comprises accessing a manifest file stored on the IFE system. The manifest file can monitor the plurality of compute resources, e.g., by requesting information about their real-time excess compute capacities therefrom on demand and/or at predetermined intervals. The manifest file can be stored on a headend server or other memory on the airplane, and/or may be access from a ground server. Furthermore, in some embodiments, determining the anticipated excess compute capacities of the plurality of compute resources comprises analyzing historical compute resource usage data associated with a current flight route. For example, different flight routes may be associated with different compute resource usages, and focusing on historical data associated with flight routes that are identical or sufficiently similar to the current flight route can provide a more accurate prediction of anticipated excess compute capacities.

At block 404, the method 400 continues by identifying one or more compute resources among the plurality of compute resources based on the one or more compute resources having real-time and/or anticipated excess compute capacities above a threshold. For example, as discussed above with reference to FIG. 3, one or more processors (e.g., the processors 334, 354) included in one or more seatboxes (e.g., the seatboxes 332, 352) associated with first class, business class, and/or economy class seats can be identified, and the seatboxes can include additional processors and/or portions thereof having a compute capacity sufficient to meet computational demands of corresponding ones of the first class and/or business class seats. To illustrate, a particular passenger seat may not be occupied during a flight, leaving the processors dedicated to that seat available for use by other systems or devices, and/or a particular passenger seat may be occupied but the passenger may not be fully utilizing the processors dedicated to their seat (e.g., the passenger may be asleep or using their PED), leaving those processors similarly available for use by other systems or devices. In another example, one or processors not associated with a passenger seat (e.g., the processors 344) can be identified. In yet another example, one or processors associated with a passenger seat without a passenger (i.e., an unoccupied passenger seat) can be identified. The threshold can be based at least in part on historical usage patterns, predefined performance metrics, or specific operational requirements of the IFE system. By analyzing historical data, the system can establish a baseline for typical resource usage and identify deviations (e.g., particularly computationally intensive tasks) that may require extra capacity. Predefined performance metrics, such as CPU utilization, memory usage, and network bandwidth, can also be used to set the threshold to ensure optimal performance. Additionally, specific operational requirements, such as the need to support a certain number of concurrent airplane passengers or to maintain a particular quality of service, can influence the threshold value.

At block 406, the method 400 continues by forming one or more compute clusters (e.g., the compute clusters 338, 348 of FIG. 3). The identified one or more compute resources and a headend server of the IFE system (e.g. the server 320) can form one or more cluster nodes of the one or more compute clusters.

At block 408, the method 400 continues by obtaining an allocation scheme. The allocation scheme can define a distribution of computational tasks among the one or more cluster nodes of the one or more compute clusters. In some embodiments, obtaining the allocation scheme comprises dynamically determining the allocation scheme based at least in part on a real-time and/or anticipated excess compute capacity of each of the one or more cluster nodes of the one or more compute clusters. For examples, each of the one or more cluster nodes can communicate its current and/or expected computational bandwidth, and the allocation scheme can dedicate a greater number of and/or more intensive computational tasks to cluster nodes with greater current and/or expected computational bandwidth.

In some embodiments, obtaining the allocation scheme comprises referencing a predetermined allocation scheme that is based at least in part on types of the computational tasks. For example, the predetermined allocation scheme can dedicate (i) relatively less intensive computational tasks to the first compute cluster 338, (ii) relatively average intensive computational tasks to the second compute cluster 348, which may generally have greater compute capacity than the first compute cluster 338, and (iii) relatively more intensive computational tasks to the IFE headend server, which may generally have greater compute capacity than the first and second compute clusters 338, 348.

In some embodiments, the allocation scheme can define the distribution of computational tasks among the one or more cluster nodes of the one or more compute clusters based at least in part on achieving uniformity of compute capacity utilization across the one or more cluster nodes of the one or more compute clusters. For example, after dedicating a first computational task to one of the cluster nodes, the IFE system can reevaluate compute capacities of the cluster nodes to determine to which a second computational task should be dedicated.

At block 410, the method 400 continues by assigning the computational tasks to the one or more cluster nodes of the one or more compute clusters based at least in part on the obtained allocation scheme. In some embodiments, assigning the computational tasks comprises employing a container orchestration system and/or an Internet of Things (IoT) system to assign the computational tasks to the one or more cluster nodes of the one or more compute clusters based at least in part on the obtained allocation scheme. The computational tasks can include, e.g., providing video live streaming (VLS) between passengers seats, providing augmented reality/virtual reality (AR/VR) services, and/or other IFE services.

In some embodiments, a hybrid model in which the seat-based compute resources (e.g., the IFE devices 330, 350) are used to augment server side capacity and form a larger overall compute cluster can be employed. For example, the method 400 can further include assigning IFE headend server side computational tasks to the identified one or more compute resources. In some embodiments, the method 400 further comprises updating the one or more compute resources in the IFE system, thereby enabling the IFE system to accommodate new services without modifying the headend server of the IFE system, replacing the headend server of the IFE system, or rewiring IFE system.

Referring to FIGS. 1-4 together, by making use of excess, spare, or otherwise available compute capacity on hardware installed on or around passenger seats, embodiments of the present technology not only reduce the workload on headend servers, but also leverage processors on IFE devices, which may include more advanced features and capabilities compared to the processors included in headend servers. Compared to headend servers, individual IFE devices are often easier and cheaper to update and/or replace. Therefore, the overall IFE system can scale and adapt to new technologies more efficiently and in a more cost-effective manner, and without the need to upgrade or replace the headend servers and/or rewire the aircraft. Overall, embodiments of the present technology provide the ability to scale up services dynamically across the IFE system beyond the capacity originally provisioned with the installed hardware so that (i) the available compute resources can be used more efficiently and (ii) the IFE system as a whole can more easily incorporate new software services over the life of the hardware installed in the aircraft.

### IV. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

1. A method for distributing workload across an in-flight entertainment (IFE) system, the method comprising:
determining real-time and anticipated excess compute capacities of a plurality of compute resources in the IFE system, wherein determining comprises accessing a manifest file stored on the IFE system and configured to monitor the plurality of compute resources, and wherein determining the anticipated excess compute capacities of the plurality of compute resources comprises analyzing historical compute resource usage data associated with a current flight route;
identifying one or more compute resources among the plurality of compute resources based on the one or more compute resources having real-time and/or anticipated excess compute capacities above a threshold;
forming one or more compute clusters, wherein the identified one or more compute resources and a headend server of the IFE system form cluster nodes of the one or more compute clusters;
obtaining an allocation scheme, wherein the allocation scheme defines a distribution of computational tasks among the cluster nodes of the one or more compute clusters; and
assigning the computational tasks to the cluster nodes of the one or more compute clusters based at least in part on the obtained allocation scheme.

2. The method of example 1, wherein identifying the one or more compute resources comprises identifying one or more first processors included in one or more seatboxes associated with first class and/or business class seats, and wherein the one or more seatboxes include one or more second processors having a compute capacity sufficient to meet computational demands of corresponding ones of the first class and/or business class seats.

3. The method of example 1 or example 2, wherein identifying the one or more compute resources comprises identifying one or more processors not associated with a passenger seat.

4. The method of any of examples 1-3, wherein identifying the one or more compute resources comprises identifying at least one of each of seatboxes, seatback monitors, and area distribution boxes of the IFE system.

5. The method of any of examples 1-4, wherein obtaining the allocation scheme comprises dynamically determining the allocation scheme based at least in part on a real-time and/or anticipated excess compute capacity of each of the cluster nodes of the one or more compute clusters.

6. The method of any of examples 1-5, wherein obtaining the allocation scheme comprises referencing a predetermined allocation scheme, wherein the predetermined allocation scheme is based at least in part on types of the computational tasks.

7. The method of any of examples 1-6, wherein the allocation scheme defines the distribution of computational tasks among the cluster nodes of the one or more compute clusters based at least in part on achieving uniformity of compute capacity utilization across the cluster nodes of the one or more compute clusters.

8. The method of any of examples 1-7, further comprising assigning IFE headend server side computational tasks to the identified one or more compute resources.

9. The method of any of examples 1-8, further comprising updating the one or more compute resources in the IFE system, thereby enabling the IFE system to accommodate new services without modifying the headend server of the IFE system, replacing the headend server of the IFE system, or rewiring IFE system.

10. The method of any of examples 1-9, wherein identifying the one or more compute resources comprises identifying one or more processors associated with a passenger seat without a passenger.

11. The method of any of examples 1-10, wherein assigning the computational tasks comprises employing a container orchestration system to assign the computational tasks to the cluster nodes of the one or more compute clusters based at least in part on the obtained allocation scheme.

12. The method of any of examples 1-11, wherein assigning the computational tasks comprises employing an Internet of Things (IoT) system to assign the computational tasks to the cluster nodes of the one or more compute clusters based at least in part on the obtained allocation scheme.

13. The method of any of examples 1-12, wherein the computational tasks include providing video live streaming (VLS) between passengers seats.

14. An in-flight entertainment (IFE) system, the IFE system comprising:
an IFE headend server; and
a plurality of seat-based compute resources, each operably coupled to the IFE headend server,
wherein the IFE headend server and/or the plurality of seat-based compute resources include one or more processors configured to:
   determine real-time and anticipated excess compute capacities of the plurality of seat-based compute resources, wherein determining comprises accessing a manifest file stored on the IFE system and configured to monitor the plurality of seat-based compute resources, and wherein determining the anticipated excess compute capacities of the plurality of seat-based compute resources comprises analyzing historical compute resource usage data associated with a current flight route;
   identify one or more compute resources among the plurality of seat-based compute resources based on the one or more compute resources having real-time and/or anticipated excess compute capacities above a threshold;
   form one or more compute clusters, wherein the identified one or more compute resources and the IFE headend server form cluster nodes of the one or more compute clusters;
   obtain an allocation scheme, wherein the allocation scheme defines a distribution of computational tasks among the cluster nodes of the one or more compute clusters; and
   assign the computational tasks to the cluster nodes of the one or more compute clusters based at least in part on the obtained allocation scheme.

15. The IFE system of example 14, wherein the plurality of seat-based compute resources include one or more first processors and one or more second processors, each included in a seatbox associated with first class and/or business class seats, wherein the one or more first processors have a compute capacity sufficient to meet computational demands of corresponding ones of the first class and/or business class seats, and wherein the one or more processors are configured to form the one or more compute clusters based on identifying the one or more second processors.

16. The IFE system of example 14 or example 15, wherein the plurality of seat-based compute resources include one or more processors, each included in a seatbox associated with economy class seats and having a compute capacity at least twice the compute capacity necessary to meet computational demands of corresponding ones of the economy class seats.

17. The IFE system of any of examples 14-16, further comprising a plurality of compute resources not associated with a passenger seat.

18. The IFE system of any of examples 14-17, wherein the one or more processors are included in the IFE headend server and not included in the plurality of seat-based compute resources.

19. The IFE system of any of examples 14-18, wherein the one or more processors are included in both the IFE headend server and the plurality of seat-based compute resources.

20. A non-transitory computer-readable medium having instructions configured to cause one or more processors of an in-flight entertainment (IFE) system to perform a method, the method comprising:
determining real-time and anticipated excess compute capacities of a plurality of compute resources in the IFE system, wherein determining comprises accessing a manifest file stored on the IFE system and configured to monitor the plurality of compute resources, and wherein determining the anticipated excess compute capacities of the plurality of compute resources comprises analyzing historical compute resource usage data associated with a current flight route;
identifying one or more compute resources among the plurality of compute resources based on the one or more compute resources having real-time and/or anticipated excess compute capacities above a threshold;
forming one or more compute clusters, wherein the identified one or more compute resources and a headend server of the IFE system form cluster nodes of the one or more compute clusters;
obtaining an allocation scheme, wherein the allocation scheme defines a distribution of computational tasks among the cluster nodes of the one or more compute clusters; and
assigning the computational tasks to the cluster nodes of the one or more compute clusters based at least in part on the obtained allocation scheme.

21. A method for distributing workload across an in-flight entertainment (IFE) system, the method comprising:
determining real-time and anticipated excess compute capacities of a plurality of compute resources in the IFE system, wherein determining comprises accessing a manifest file stored on the IFE system and configured to monitor the plurality of compute resources, and wherein determining the anticipated excess compute capacities of the plurality of compute resources comprises analyzing historical compute resource usage data associated with a current flight route;
identifying one or more compute resources among the plurality of compute resources based on the one or more compute resources having real-time and/or anticipated excess compute capacities above a threshold;
forming one or more compute clusters, wherein the identified one or more compute resources and a headend server of the IFE system form cluster nodes of the one or more compute clusters;
obtaining an allocation scheme, wherein the allocation scheme defines a distribution of computational tasks among the cluster nodes of the one or more compute clusters; and
assigning the computational tasks to the cluster nodes of the one or more compute clusters based at least in part on the obtained allocation scheme.

22. A method for distributing workload across an in-flight entertainment (IFE) system, the method comprising:
forming one or more compute clusters, wherein forming the one or more compute clusters comprises identifying one or more compute resources in the IFE system having real-time and/or anticipated excess compute capacity, and wherein the identified one or more compute resources and a headend server of the IFE system form one or more cluster nodes of the one or more compute clusters;
obtaining an allocation scheme, wherein the allocation scheme defines a distribution of computational tasks among the one or more cluster nodes of the one or more compute clusters; and
assigning the computational tasks to the one or more cluster nodes of the one or more compute clusters based at least in part on the obtained allocation scheme.

23. An in-flight entertainment (IFE) system, the IFE system comprising:
an IFE headend server; and
a plurality of seat-based compute resources, each operably coupled to the IFE headend server,
wherein the IFE headend server and/or the plurality of seat-based compute resources include one or more processors configured to:
   form one or more compute clusters, wherein the one or more compute clusters are formed based on identifying one or more of the plurality of seat-based compute resources having real-time and/or anticipated excess compute capacity, and wherein the identified one or more of the plurality of seat-based compute resources and the IFE headend server form one or more cluster nodes of the one or more compute clusters;
   obtain an allocation scheme, wherein the allocation scheme defines a distribution of computational tasks among the one or more cluster nodes of the one or more compute clusters; and
   assign the computational tasks to the one or more cluster nodes of the one or more compute clusters based at least in part on the obtained allocation scheme.

24. A non-transitory computer-readable medium having instructions configured to cause

one or more processors of an in-flight entertainment (IFE) system to perform a method, the method comprising:
forming one or more compute clusters, wherein forming the one or more compute clusters comprises identifying one or more compute resources in the IFE system having real-time and/or anticipated excess compute capacity, and wherein the identified one or more compute resources and a headend server of the IFE system form one or more cluster nodes of the one or more compute clusters;
obtaining an allocation scheme, wherein the allocation scheme defines a distribution of computational tasks among the one or more cluster nodes of the one or more compute clusters; and
assigning the computational tasks to the one or more cluster nodes of the one or more compute clusters based at least in part on the obtained allocation scheme.

### V. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. A method for distributing workload across an in-flight entertainment (IFE) system, the method comprising:
determining real-time and anticipated excess compute capacities of a plurality of compute resources in the IFE system, wherein determining comprises accessing a manifest file stored on the IFE system and configured to monitor the plurality of compute resources, and wherein determining the anticipated excess compute capacities of the plurality of compute resources comprises analyzing historical compute resource usage data associated with a current flight route;
identifying one or more compute resources among the plurality of compute resources based on the one or more compute resources having real-time and/or anticipated excess compute capacities above a threshold;
forming one or more compute clusters, wherein the identified one or more compute resources and a headend server of the IFE system form cluster nodes of the one or more compute clusters;
obtaining an allocation scheme, wherein the allocation scheme defines a distribution of computational tasks among the cluster nodes of the one or more compute clusters; and
assigning the computational tasks to the cluster nodes of the one or more compute clusters based at least in part on the obtained allocation scheme.

1. The method of claim 1, wherein identifying the one or more compute resources comprises identifying one or more first processors included in one or more seatboxes associated with first class and/or business class seats, and wherein the one or more seatboxes include one or more second processors having a compute capacity sufficient to meet computational demands of corresponding ones of the first class and/or business class seats.

2. The method of claim 1, wherein identifying the one or more compute resources comprises identifying one or more processors not associated with a passenger seat.

3. The method of claim 1, wherein identifying the one or more compute resources comprises identifying at least one of each of seatboxes, seatback monitors, and area distribution boxes of the IFE system.

4. The method of claim 1, wherein obtaining the allocation scheme comprises dynamically determining the allocation scheme based at least in part on a real-time and/or anticipated excess compute capacity of each of the cluster nodes of the one or more compute clusters.

5. The method of claim 1, wherein obtaining the allocation scheme comprises referencing a predetermined allocation scheme, wherein the predetermined allocation scheme is based at least in part on types of the computational tasks.

6. The method of claim 1, wherein the allocation scheme defines the distribution of computational tasks among the cluster nodes of the one or more compute clusters based at least in part on achieving uniformity of compute capacity utilization across the cluster nodes of the one or more compute clusters.

7. The method of claim 1, further comprising assigning IFE headend server side computational tasks to the identified one or more compute resources.

8. The method of claim 1, further comprising updating the one or more compute resources in the IFE system, thereby enabling the IFE system to accommodate new services without modifying the headend server of the IFE system, replacing the headend server of the IFE system, or rewiring IFE system.

9. The method of claim 1, wherein identifying the one or more compute resources comprises identifying one or more processors associated with a passenger seat without a passenger.

10. The method of claim 1, wherein assigning the computational tasks comprises employing a container orchestration system to assign the computational tasks to the cluster nodes of the one or more compute clusters based at least in part on the obtained allocation scheme.

11. The method of claim 1, wherein assigning the computational tasks comprises employing an Internet of Things (IoT) system to assign the computational tasks to the cluster nodes of the one or more compute clusters based at least in part on the obtained allocation scheme.

12. The method of claim 1, wherein the computational tasks include providing video live streaming (VLS) between passengers seats.

13. An in-flight entertainment (IFE) system, the IFE system comprising:
an IFE headend server; and
a plurality of seat-based compute resources, each operably coupled to the IFE headend server, wherein the IFE headend server and/or the plurality of seat-based compute resources include
one or more processors configured to:
determine real-time and anticipated excess compute capacities of the plurality of seat-based compute resources, wherein determining comprises accessing a manifest file stored on the IFE system and configured to monitor the plurality of seat-based compute resources, and wherein determining the anticipated excess compute capacities of the plurality of seat-based compute resources comprises analyzing historical compute resource usage data associated with a current flight route;
identify one or more compute resources among the plurality of seat-based compute resources based on the one or more compute resources having real-time and/or anticipated excess compute capacities above a threshold;
form one or more compute clusters, wherein the identified one or more compute resources and the IFE headend server form cluster nodes of the one or more compute clusters;
obtain an allocation scheme, wherein the allocation scheme defines a distribution of computational tasks among the cluster nodes of the one or more compute clusters; and
assign the computational tasks to the cluster nodes of the one or more compute clusters based at least in part on the obtained allocation scheme.

14. The IFE system of claim 14, wherein the plurality of seat-based compute resources include one or more first processors and one or more second processors, each included in a seatbox associated with first class and/or business class seats, wherein the one or more first processors have a compute capacity sufficient to meet computational demands of corresponding ones of the first class and/or business class seats, and wherein the one or more processors are configured to form the one or more compute clusters based on identifying the one or more second processors.

15. The IFE system of claim 14, wherein the plurality of seat-based compute resources include one or more processors, each included in a seatbox associated with economy class seats and having a compute capacity at least twice the compute capacity necessary to meet computational demands of corresponding ones of the economy class seats.

16. The IFE system of claim 14, further comprising a plurality of compute resources not associated with a passenger seat.

17. The IFE system of claim 14, wherein the one or more processors are included in the IFE headend server and not included in the plurality of seat-based compute resources.

18. The IFE system of claim 14, wherein the one or more processors are included in both the IFE headend server and the plurality of seat-based compute resources.

19. A non-transitory computer-readable medium having instructions configured to cause one or more processors of an in-flight entertainment (IFE) system to perform a method, the method comprising:
determining real-time and anticipated excess compute capacities of a plurality of compute resources in the IFE system, wherein determining comprises accessing a manifest file stored on the IFE system and configured to monitor the plurality of compute resources, and wherein determining the anticipated excess compute capacities of the plurality of compute resources comprises analyzing historical compute resource usage data associated with a current flight route;
identifying one or more compute resources among the plurality of compute resources based on the one or more compute resources having real-time and/or anticipated excess compute capacities above a threshold;
forming one or more compute clusters, wherein the identified one or more compute resources and a headend server of the IFE system form cluster nodes of the one or more compute clusters;
obtaining an allocation scheme, wherein the allocation scheme defines a distribution of computational tasks among the cluster nodes of the one or more compute clusters; and
assigning the computational tasks to the cluster nodes of the one or more compute clusters based at least in part on the obtained allocation scheme.
